(19) United States
(12) Patent Application Publication
(10) Pub. No.: US 2007/0203849 A1
(43) Pub. Date: Aug. 30, 2007

(54) Endpoint verification using common attributes

(75) Inventors: Kim Cameron, Bellevue, WA (US); Arun K. Nanda, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/361,110

(22) Filed: Feb. 24, 2006

(51) Int. Cl. G06Q 99/00

(52) U.S. Cl. 705/67

(57) ABSTRACT

A system for endpoint verification includes a computer system programmed to access one web site of a plurality of web sites associated with an organization. The computer system is programmed to receive a digital certificate of the web site and to display an attribute from the digital certificate to the user for endpoint verification. The attribute is common across two or more of the web sites of the organization.

### BACKGROUND

The use of online services for business and pleasure is increasing. For example, many individuals utilize web sites on the Internet to conduct business that previously was done in person or over the telephone. A user can reach a web site on the Internet by typing the web site's uniform resource locator (“URL”) into a browser running on the user's computer. In some situations, the user may want to verify that the user has actually reached the desired web site. Verification that the user has reached the desired can be important for various reasons. For example, verification that the user has reached the desired web site minimizes the impact of fraudulent activities such as phishing and pharming that can result in identity theft and monetary losses. In addition, verification can bolster a user's confidence and increase the user's desire to transact with the web site.

One method to verify that the user has reached the desired web site is to download the digital certificate of the web site issued by a trusted third party. The trusted third party vouches for the content of the digital certificate. The unique Domain Name System (“DNS”) Name (i.e., “CommonName” or “CN”) from the digital certificate can be displayed to the user to allow the use to verify that the desired web site has been reached. For example, if the user attempts to reach microsoft.com, one way to verify that the user has in fact reached the desired web site is to display the DNS Name (e.g., “www.microsoft.com”) from the digital certificate associated with the web site to the user.

This form of endpoint verification can have drawbacks for organizations that own or are otherwise associated with multiple web sites having unique domain names. For example, Microsoft Corporation of Redmond, Wash. owns multiple web sites with different domain names such as, for example, the “windowsmarketplace.com” and “msn.com” web sites. The DNS Name in the digital certificate for each of these web sites differs and does not necessarily indicate that both web sites are owned by Microsoft Corporation. The user may therefore have difficulty verifying whether the user has reached the desired web site when the DNS Name is displayed, since the DNS Name can differ for web sites owned or associated with the same organization.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect relates to a system for endpoint verification including a computer system programmed to access one web site of a plurality of web sites associated with an organization. The computer system is programmed to receive a digital certificate of the web site and to display an attribute from the digital certificate to the user for endpoint verification. The attribute is common across two or more of the web sites of the organization.

Another aspect relates to a method of providing endpoint verification, the method including: accessing one of a plurality of web sites associated with an organization; receiving a digital certificate of the web site; and displaying an attribute from the digital certificate to the user for endpoint verification, the attribute being common across two or more of the web sites of the organization.

Yet another aspect relates to a computer-readable medium having computer-executable instructions for performing steps including: accessing one of a plurality of web sites associated with an organization; receiving a digital certificate of the web site; and displaying an attribute from the digital certificate to the user for endpoint verification, the attribute being common across two or more of the web sites of the organization.

### DESCRIPTION OF THE DRAWINGS

Reference will now be made to the accompanying drawings, which are not necessarily drawn to scale, and wherein:

FIG. 1 illustrates an example computing environment in which an embodiment of a computer system programmed to provide endpoint verification is shown;

FIG. 2 illustrates the example computer system and a web site of FIG. 1;

FIG. 3 illustrates an example graphical user interface of the computer system of FIG. 1 including a display of endpoint verification;

FIG. 4 illustrates another example graphical user interface of the computer system of FIG. 1 including a display of endpoint verification;

FIG. 5 illustrates an example method for providing endpoint verification; and

FIG. 6 illustrates another example method for providing endpoint verification.

### DETAILED DESCRIPTION

Example embodiments will now be described more fully hereinafter with reference to the accompanying drawings. These embodiments are provided so that this disclosure will be thorough and complete. Like numbers refer to like elements throughout.

Example embodiments disclosed herein relate generally to the verification of the identity of a web site. In example embodiments, a user is presented with information related to the web site. The user can use this information to verify that the user has reached the desired web site, and/or to otherwise increase the user's confidence and desire to transact with the web site because the user is aware of the web site's affiliation with other entities with which the user has a positive and/or trusted relationship.

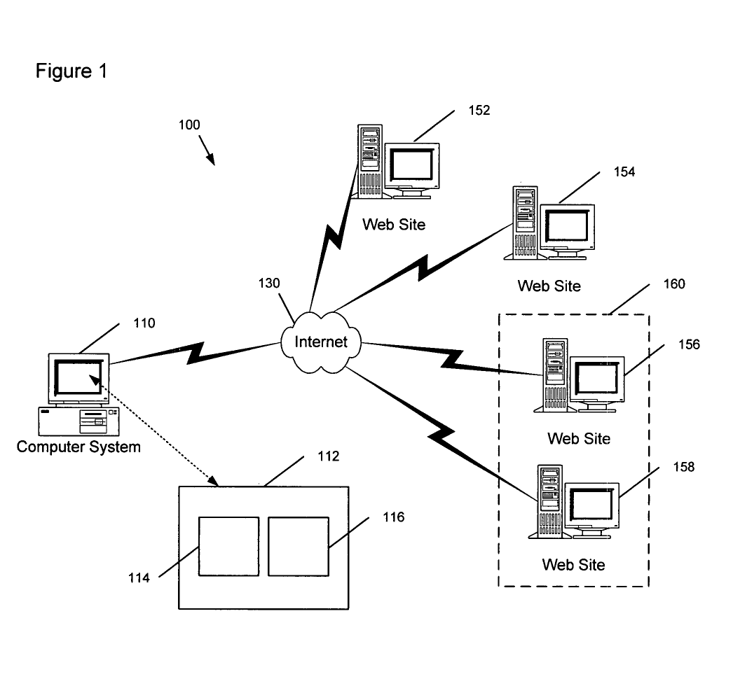

Referring now to FIG. 1, an example computing environment 100 includes embodiments of a computer system 110, a network such as the Internet 130, and a plurality of web sites 152, 154, 156, 158. Example computer system 110 is controlled by a user to communicate through Internet 130 with one or more of web sites 152, 154, 156, 158.

In the example shown, computer system 110 is configured as a personal computer including at least one processor and memory. Computer system 110 includes one or more of volatile and non-volatile computer readable media. Computer readable media includes storage media, as well as removable and non-removable media implemented in any method or technology for storage of information such as computer readable instructions, data structures, program modules or other data. The computer system also includes communication media that typically embodies computer readable instructions, data structures, program modules or other data in a modulated data signal such as a carrier wave or other transport mechanism and includes any information delivery media. Communication media includes wired media such as a wired network or direct-wired connection, and wireless media such as acoustic, RF, infrared and other wireless media. Combinations of any of the above can also be included.

Computer system 110 includes an operation system, such as the WINDOWS operating system from Microsoft Corporation, and one or more programs stored on the computer readable media. Computer system 110 can also include one or more input and output communications devices that allow the user to communicate with computer system 110, as well as allow computer system 110 to communicate with other devices, such as the Internet 130 and web sites 152, 154, 156, 158. One example output device shown in FIG. 1 is a display 112.

In example embodiments, computer system 110 is connected to and can communicate with web sites 152, 154, 156, 158 through the Internet 130. In alternative embodiments, the Internet 130 can also be a local area network (LAN) or a wide area network (WAN). Communications between computer system 110, the Internet 130, and web sites 152, 154, 156, 158 can be implemented using wired and/or wireless technologies.

The user of computer system 10 can access one or more of web sites 152, 154, 156, 158 using a program on computer system 110 such as a browser 114. One example of a browser is the Internet Explorer browser offered by Microsoft Corporation. In one embodiment, browser 114 running on computer system 110 communicates with one or more of web sites 152, 154, 156, 158 using the hypertext transport protocol (“HTTP”) or hypertext transport protocol secure (“HTTPS”).

Other programs and protocols can be used. For example, in one alternative embodiment, computer 110 includes a smart/rich client application that interacts with one or more of web sites 152, 154, 156, 158 using extensible markup language (“XML”) and/or the simple object access protocol. In another alternative embodiment, the site accessed by computer system 110 is a file transfer protocol (“FTP”) site, and the application running on the user's computer system is an ftp client that communicates according to the FTP protocol.

As illustrated in FIG. 1, each of web sites 152, 154, 156, 158 is separately accessible using a unique domain name. Although web sites 156, 158 have unique domain names, both are associated with a same organization 160. For example, in some embodiments, organization 160 owns or is otherwise affiliated with web sites 156, 158. Web sites 156, 158 can be hosted on a common server or can be hosted on multiple different servers.

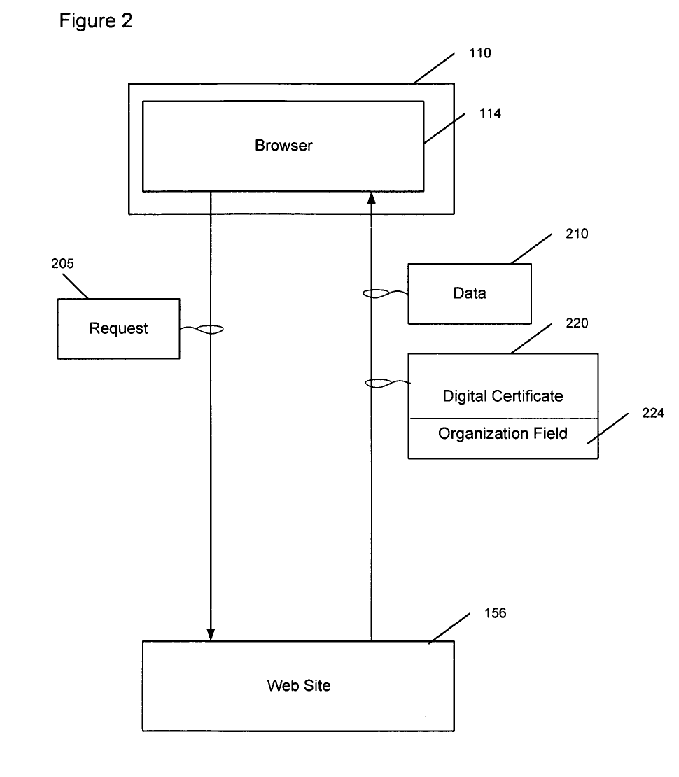

Referring now to FIG. 2, when computer system 110 connects to one of web sites 152, 154, 156, 158, such as web site 156, system 110 sends a request 205 to web site web site 156 for information. In response to request 205, web site 156 is programmed to provide data 210 to computer system 110. Examples of data 210 provided by web site 156 include hypertext markup language (“HTML”) and/or XML pages, executable files, etc. Other types of data can also be used.

In the example shown, web site 156 (or a third party) can also provide a digital certificate 220 to computer system 110 to authenticate the identity of web site 156. In one example, digital certificate 220 is issued by a certification authority in accordance with the X.509 standard digital certificate format promulgated by the ITU Telecommunication Standardization Sector (“ITU-T”). In alternative embodiments, other formats for digital certificate 220 can be used.

Referring again to FIG. 1, when computer system 110 receives digital certificate 220 associated with web site 156, computer system 110 is programmed to display an attribute from digital certificate 220 on display 112 to provide endpoint verification for the user. The user can review the displayed attribute on display 112 to determine that the user has reached the desired location, and/or to determine whether or not to trust the web site.

In embodiments disclosed herein, the attribute displayed to the user is an attribute that is common across both web sites 156, 158 associated with organization 160. In example embodiments, the common attribute is selected to allow the user to identify that both of web sites 156, 158 are affiliated with organization 160. For example, in some embodiments, the common attribute is selected to reflect the name of organization 160 or a trade/service mark of organization 160. In this manner, even though web sites 156, 158 have unique domain names, endpoint verification can be provided to the user to show that web sites 156, 158 are both associated with organization 160.

In one example embodiment, the common attribute is selected to be one or more of the following fields specified in the X.509 format for a digital certificate:
“Organization” or “O”—the legal name of the organization; and/or
“OrgUnit” or “OU”—the name of the organization's sub-organization or department.
   For example, the common attribute can be an organization field 224 from digital certificate 220.

In yet other examples, other common attributes can be used. For example, in one alternative embodiment, a separate field can be defined in digital certificate 220. This field can be populated with information (e.g., organization name, trade/service name, trade logo, etc.) that is common across multiple web sites associated with an organization so that the organization is identified to the user when endpoint verification is conducted.

For example, in one embodiment, organization 160 is Microsoft Corporation of Redmond, Wash. Web sites 156, 158 are multiple web sites with different domain names owned by Microsoft Corporation such as, for example, the “windowsmarketplace.com” and “msn.com” web sites. When the user uses computer system 110 to access one of web sites 156, 158, such as windowsmarketplace.com, digital certificate 220 for windowsmarketplace.com is sent to computer system 110. Computer system 110 is programmed to display a common attribute from digital certificate 220 to the user for endpoint verification. This common attribute indicates that the web site accessed by the user (i.e., windowsmarketplace.com) is a web site owned by Microsoft Corporation.

If the user accesses the msn.com web site, the user is likewise presented with the common attribute from the digital certificates 220 of the msn.com web site that indicates that the web site is also owned by Microsoft Corporation. In this manner, endpoint verification shows the user that both web sites 156, 158 are owned by the same organization 160, Microsoft Corporation. Such information can be used by the user for a variety of purposes including, but not limited to, verification that the user has reached the desired location, and a determination as to whether or not to trust the web site based on the affiliation.

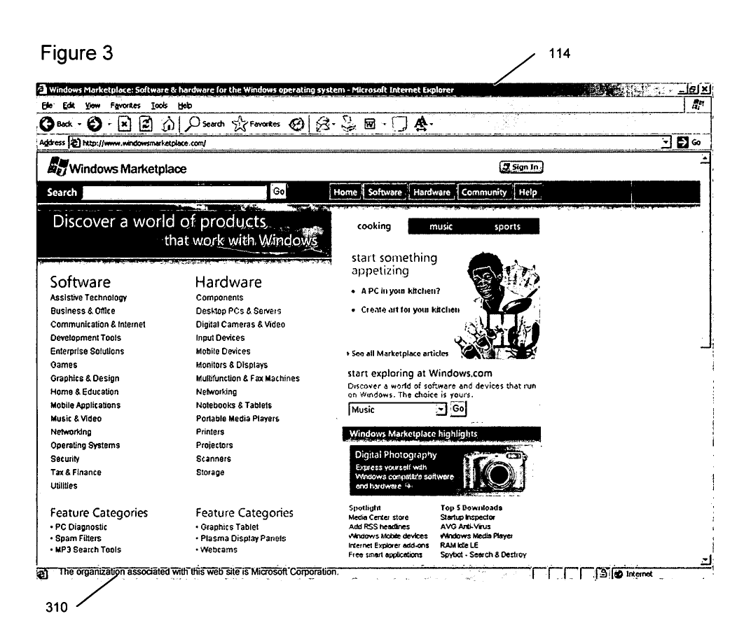

Referring now to FIG. 3, example browser 114 of computer system 110 is shown. Browser 114 includes an example endpoint verification display 310 provided in the status bar of browser 114. For example, in the illustrated embodiment, endpoint verification display 310 indicates that the organization associated with the windowsmarketplace.com web site shown in browser 114 is Microsoft Corporation.

In alternative embodiments, the information from endpoint verification can be displayed in alternative places in browser 114, such as a banner positioned under the address bar of browser 114. In yet other embodiments, the endpoint verification information can be displayed in a separate window, such as another browser window or a separate graphical user interface, as described further below.

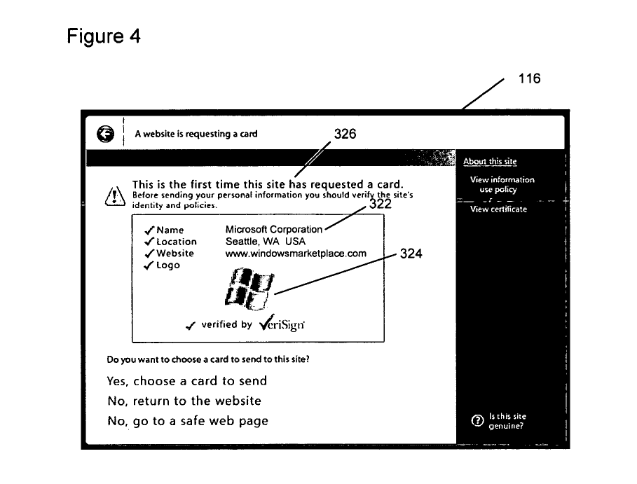

For example, referring now to FIG. 4, in an alternative embodiment, separate graphical user interface 116 is utilized to show the information for endpoint verification. Specifically, example user interface 116 includes the organizational name 322 (“Microsoft Corporation”) and the organization logo 324 associated with the windowsmarketplace.com web site. User interface 116 also provides an indicator 326 that shows whether or not the user has visited the particular web site in the past. In alternative embodiments, other similar characteristics that are common across web sites owned by a entity can be used as well.

In some embodiments, the verification information presented to the user is marked to provide additional information associated with endpoint verification. For example, the information can be provided in different colors (e.g., red or green) to indicate different levels of trustworthiness of the web site being accessed. In yet other embodiments, other types of visual or audible indicators such as graphical indicators can be used. The endpoint verification information can be persistent, or can be displayed for a specified period of time.

For example, in one alternative embodiment, computer system 110 is programmed to review the common attribute, such as organization name, in digital certificate 220 associated with web site 156 to determine if the user has a preexisting relationship with the organization and/or has previously visited one or more web sites associated with the organization. If the user does have a preexisting relationship or has previously visited one or more web sites associated with the organization, computer system 110 is programmed to visually or audibly indicate this positively to the user. If the user does not have a preexisting relationship with the organization or has not previously visited one or more web sites associated with the organization, computer system 110 is programmed to indicate this negatively to the user.

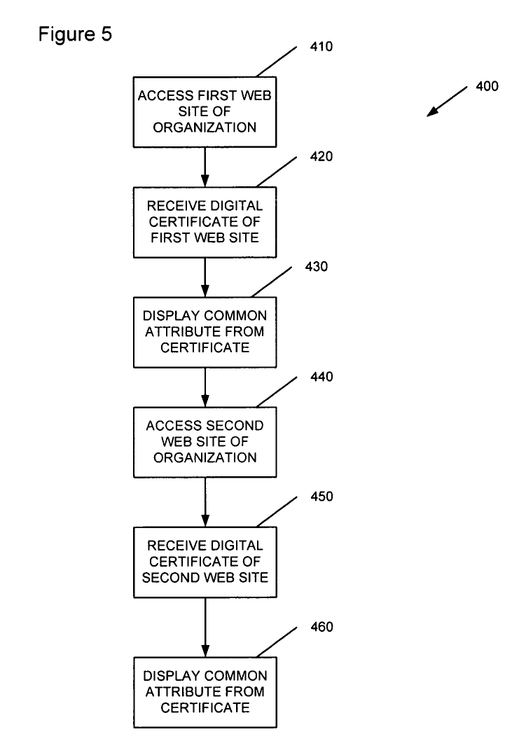

Referring now to FIG. 5, an example method 400 for endpoint verification is shown. Beginning at operation 410, the user accesses a first web site associated with an organization using, for example, a browser. Next, at operation 420, the digital certificate associated with the first web site is received by the user. At operation 430, an attribute from the digital certificate is displayed to the user. The attribute is common across two or more of the web sites associated with the organization. Next, at operation 440, the user accesses a second web site also associated with the organization. The digital certificate of the second web site is received by the user at operation 450. Next, at operation 460, the common attribute is again displayed for the user during endpoint verification so that the user can determine that the first and second web sites are both associated with the same organization.

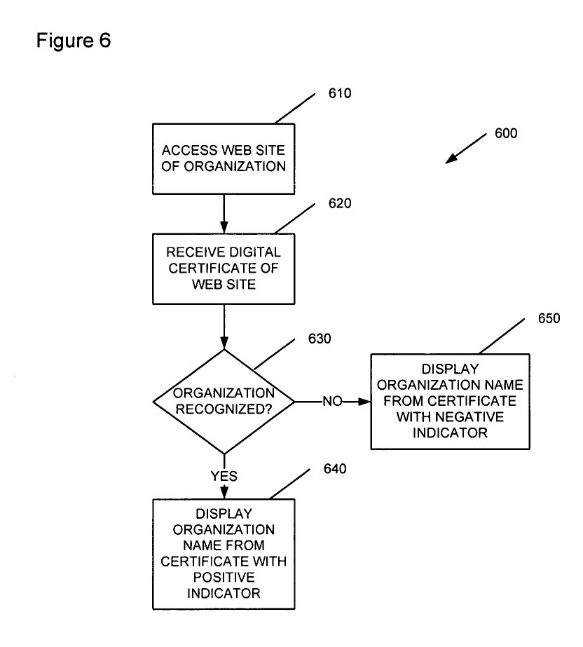

Referring now to FIG. 6, another example method 600 for endpoint verification is shown. At operation 610, the user accesses a web site of an organization. Next, at operation 620, the user receives the digital certificate of the web site. Next, at operation 630, a common attribute in the digital certificate of the web site is examined, and a determination is made as to whether the computer system recognizes the organization associated with the web site. For example, in some embodiments, the computer system is programmed to compare the attribute to a list of attributes from previously visited or otherwise trusted web sites to see if there is match.

If a match is found, control is passed to operation 640, and the common attribute is displayed to the user with a positive indicator. The positive indicator indicates that the organization associated with the web site is recognized and/or can be trusted. If a match is not found, control is instead passed to operation 650, and the common attribute is displayed to the user with a negative indicator to indicate that the organization associated with the web site is not recognized and/or may not be trusted. Examples of positive and negative indicators include visual (e.g., colors such as green for positive and red for negative, and/or icons) and audible (e.g., one or more beeps for web sites that cannot be trusted or not trusted).

The various embodiments described above are provided by way of illustration only and should not be construed to limiting. Those skilled in the art will readily recognize various modifications and changes that may be made to the embodiments described above without departing from the true spirit and scope of the disclosure or the following claims.

What is claimed is:

1. A system for endpoint verification, the system comprising a computer system programmed to access one web site of a plurality of web sites associated with an organization, the computer system being programmed to receive a digital certificate of the web site and to display an attribute from the digital certificate to the user for endpoint verification, wherein the attribute is common across two or more of the web sites of the organization.

2. The system of claim 1, wherein the attribute is an organizational name field from the digital certificate.

3. The system of claim 1, wherein the attribute is displayed to the user in a browser of the computer system during the endpoint verification.

4. A method of providing endpoint verification, the method comprising:
accessing one of a plurality of web sites associated with an organization;
receiving a digital certificate of the web site; and
displaying an attribute from the digital certificate to the user for endpoint verification, the attribute being common across two or more of the web sites of the organization.

5. The method of claim 4, wherein the attribute is an organizational name field from the digital certificate.

6. The method of claim 4, wherein displaying the attribute further comprises displaying the attribute in a browser during the endpoint verification.

7. The method of claim 4, further comprising providing an indication of trustworthiness of the web site based on review of the attribute.

8. A computer-readable medium having computer-executable instructions for performing steps comprising:
accessing one of a plurality of web sites associated with an organization;
receiving a digital certificate of the web site; and
displaying an attribute from the digital certificate to the user for endpoint verification, the attribute being common across two or more of the web sites of the organization.

9. The computer-readable medium of claim 8, wherein the attribute is an organizational name field from the digital certificate.

10. The computer-readable medium of claim 8, wherein displaying the attribute further comprises displaying the attribute in a browser during the endpoint verification.

11. The computer-readable medium of claim 8, further comprising providing an indication of trustworthiness of the web site based on review of the attribute.
